(19) United States
(12) Patent Application Publication
(10) Pub. No.: US 2012/0030025 A1
(43) Pub. Date: Feb. 2, 2012

(54) Delivering Highly Targeted Advertisements to a User of a Computing Device by Statistically Analyzing of Key Words Used in a Communication Module

(76) Inventor: Yang Pan, Singapore (SG)

(21) Appl. No.: 12/844,843

(22) Filed: Jul. 28, 2010

(51) Int. Cl. G06Q 30/00

(52) U.S. Cl. 705/14.66

(57) ABSTRACT

A method for delivering highly targeted advertisements to a user of a computing device is disclosed. Communication media files resulting from the user's interaction with communication modules of the computing device are utilized. The communication module may include voice communication, e-mail, Short Message Service (SMS), on-line chat, social network and web browsing. Key words related to categories and sub-categories of advertisements are extracted from the media files. Statistic trends of the usage of the key words are generated by a statistic processor. A significant increase or decrease in usage of anyone of the key words over a predetermined period time is employed to determine the user's most recent commercial interests. The highly targeted advertisements may be delivered without risking a leakage of the user's privacy.

### CROSS-REFERENCE TO RELATED APPLICATIONS

Not applicable.

### BACKGROUND-FIELD OF INVENTION

This invention relates generally to advertising. More specifically, the invention relates to methods for delivering highly targeted advertisement to a user of a computing device.

### BACKGROUND-DESCRIPTION OF PRIOR ART

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device. It has always been a significant challenge to understand the user's real interests and to deliver the advertising message accordingly.

### SUMMARY

It is an object of the present invention to provide an advertisement delivery system for delivering highly targeted advertisements to a user of a computing device.

It is another object of the present invention to provide an effective method for determining a user's interests in categories and/or sub-categories of advertisements based on communication media files of the computing device.

It is yet another object of the present invention to provide a novel method to extract key words from the communication media files of the computing device based on a key word library consisting of words representing commercial goods and services, brand names and retailers.

It is yet a further object of the present invention to use a statistic method to detect significant usage trend changes of the key words extracted from the communication media files and to deliver highly targeted advertisements accordingly.

According to one embodiment of the present invention, the advertisement delivery system comprises a computing device, a data manager and a communication network for connecting them. The computing device further comprises various communication modules such as, for example, voice communication, Short Message Service (SMS), e-mail, on-line chat, social networks and web browsing. Each communication module is associated with a media file. The media files may comprise words. The media files may also comprise image and/or multimedia files. When a specific communication module is used by the user, a media file is created. Some of the words in the files may be related to commercial items and services, brand names and retailers.

A key word library including a database of key words related to commercial activities may be stored in a file storage system of the computing device. The database may be sent from the data manager. The key word library may include such words as related to the current location of the user.

The key words from media files are extracted. Each key word is associated with a counter. The usage of the word by the user over a predetermined period of time is recorded. A statistic processor is used to determine if there is any significant change of the trend for anyone of the key words based on a set of predetermined rules. The advertisements are delivered according to the changes of the key word usage trend.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary advertisement delivery system for delivering highly targeted advertisements based on statistic analysis of key word used by a user in various communication media files;

FIG. 2A is a schematic diagram illustrating that a key word extractor is included in a computing device and a statistic processor is included in a data manager according to one embodiment;

FIG. 2B is a schematic diagram illustrating that the key word extractor and the statistic processor are both included in a computing device according to another embodiment;

FIG. 3 is a flowchart illustrating that a key word library is sent from the data manager to the computing device after receiving the user's location and/or personal data;

FIG. 4 is an exemplary hierarchical data file structure for categories and sub-categories of advertisements;

FIG. 5 is a flowchart illustrating an exemplary process that key words in a communication media file are extracted and are utilized to delivery targeted advertisements;

FIG. 6 is a flowchart illustrating an exemplary process that a statistic processor is used to determine if there is a significant change in anyone of key words;

FIG. 7 is a schematic illustration of three basic modes of trend changes related to key words.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

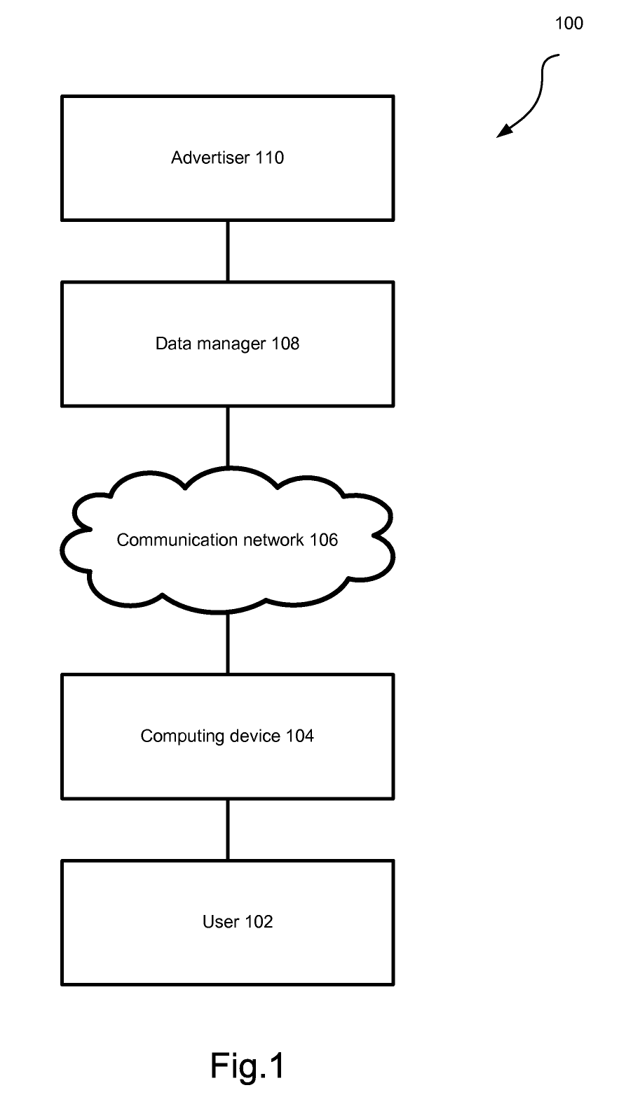

FIG. 1 is a schematic diagram of an exemplary advertisement delivery system for delivering advertisements from advertisers to a user through a communication network. The system 100 comprises a user 102 and a computing device 104. The computing device 104 may be a personal computer, a mobile communication device, a digital television system, a handheld media player; and a game console. The mobile communication device is used to illustrate exemplarily the present inventive concept without limiting the scope of the invention. The computing device 104 is connectable to a data manager 108 through a communication network 106. The communication network 106 may be the Internet. The network 106 may also be a public phone network or a broadband network for the digital television system for delivering TV programs. The data manager 108 may be a server connected to the network 106. The data manager 108 comprises an advertisement database including various categories of advertisements from advertiser 110. Multiple advertisers may be connected to the data manager 108. The data manager 108 may also be connected to manufacturers and customer rating and guiding organizations (not shown in the figure). The connections from the advertiser 110 to the data manager 108 may be through a communication network that is the same communication network as 106. The connections may be through a different communication network.

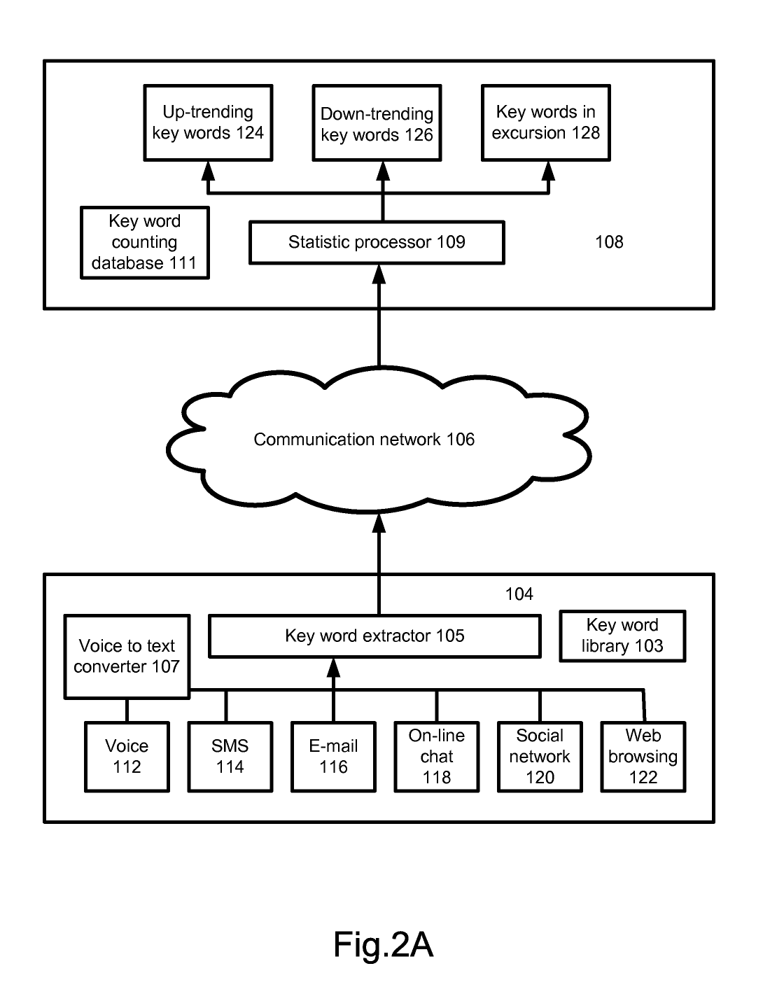

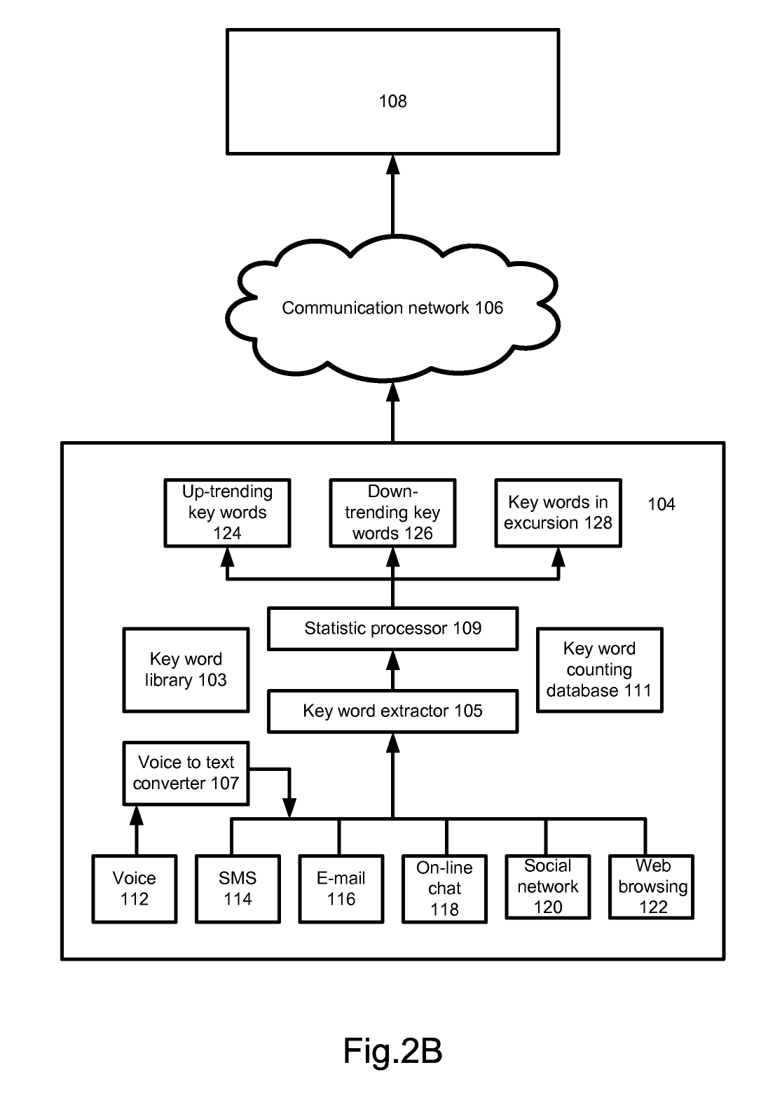

FIG. 2A is a schematic diagram illustrating that an exemplary implementation of the computing device and the data manger according to one embodiment of the present invention. The computing device 104 comprises, a key word library 103, a key word extractor 105 and various communication modules such as, for example, a voice communication module 112, a SMS 114, an e-mail module 116, an on-line chat module 118, a social network 120 and a web browsing module 122. A mobile communication device such as an iPhone from Apple Inc, Cupertino, Calif. would include all above mentioned communication modules. Each communication module is associated with a communication media file. For example, an SMS or an email is associated with a file in text format. A voice communication module is associated with a file in a voice format. If a voice file is used, a voice to text converter 107 may be used to converter words in voice format into words in text format. The method is well known in the art for the conversion.

The words in a communication media file are then compared with words in the key word library 103. The words in the key word library 103 include but not limited to the words representing commercial goods and services, brand names and local retailers. The words in the media file matched to the words in the key word library 103 are extracted and their frequencies of usage are counted. The recorded key words and their usage counts are sent to the data manager 108 through the communication network 106. A statistic processor 109 in the data manager 108 is used to analyze the received key words and their counts. The received key words and their counts may be combined with an already existed key word counting database 111 to generate key word usage trends over a predetermined period of time such as, for example, a day, a week, or a month.

The statistic processor 109 outputs key words that are up-trending (124), down-trending (126) and in an excursion (128) based on a set of predetermined rules. The changes of trend in a statistic manner may indicate a shift of the user's commercial interests, which can be utilized to deliver highly targeted advertisements to the user. The predetermined rules may include one or more than one control limits.

FIG. 2B is a schematic diagram illustrating another embodiment of the present invention. The key word library 103, the key word extractor 105, the statistic processor 109 and the key word counting database 111 are all included in the computing device 104. For such an embodiment, only the key words demonstrated a significant trend change will be sent to the data manager 108.

It has been a great challenge for the advertising industry to find a balance between protecting privacy and using personal data effectively to deliver targeted messages. The present invention provides an innovative method to resolve the issue. The method involves transmitting the key words only related to commercial goods and services or the key words that have demonstrated significant trend changes. It would be impossible for a service provider such as the data manager 108 to reconstruct a complete media file based only on selected key words. The sequence of the key words may also be intentionally randomized to further prevent leakage of the private media file to the service provider 108.

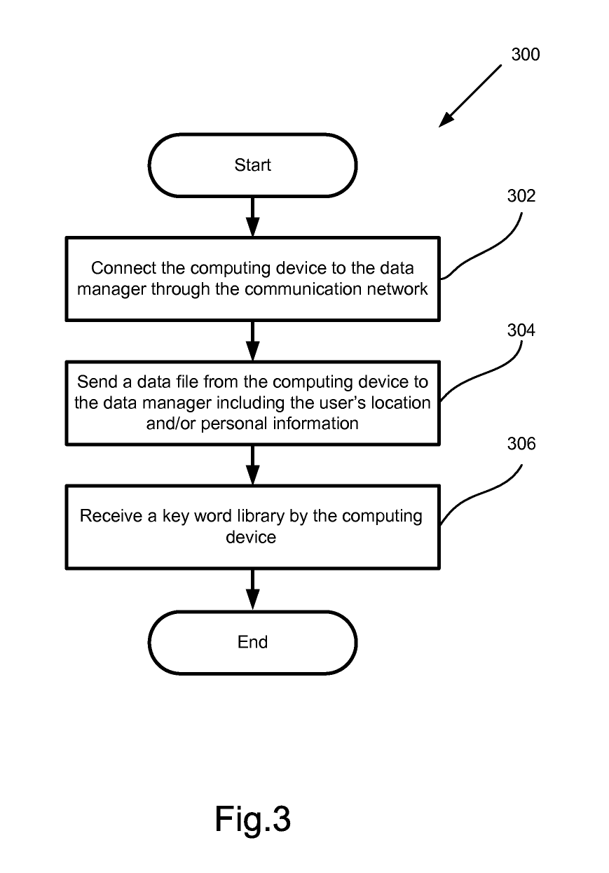

FIG. 3 is a flowchart illustrating that a key word library 103 is sent from the data manager 108 to the computing device 104 after receiving the user's location and his personal data. Process 300 starts with step 302 that the computing device 104 is connected to the data manager 108. A data file including the user's location and/or his personal information is sent from the computing device 104 to the data manager 108 in step 304. A key world library 103 for the user is constructed by the data manager 108 and is sent back to the computing device 104 in step 306.

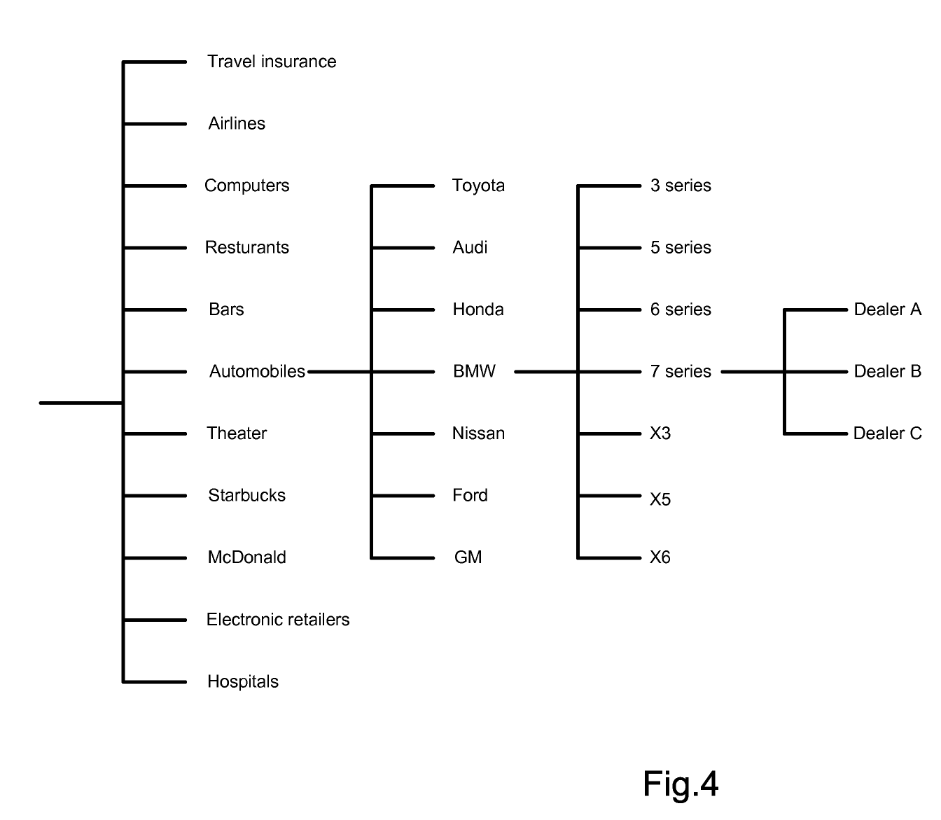

FIG. 4 is a schematic presentation of data file structure in an exemplary manner for key words in the key word library 103. Categories of commercial goods or services may include travel insurance, airlines, computers, restaurants, bars, automobiles, theaters, Starbucks, McDonald's, Electronic retailers, hospitals and many more. In an exemplary illustration, the category representing automobile may further include a sub-category including various brands including such as, for example, Toyota, Audi, Honda, BMW, Nissan, Ford and GM. Each brand may further include various models of the brand. Local dealers for specific automobile brands may also be included. The categories and sub-categories of key words may be organized in such a hierarchical manner. If “BMW” is captured by the key word extractor 105 one or multiple times in a media file, the counters associated with the “automobile” and “BMW” may be updated. The data manager 108 may include advertisements related to the key words representing the categories and/or sub-categories of advertisements.

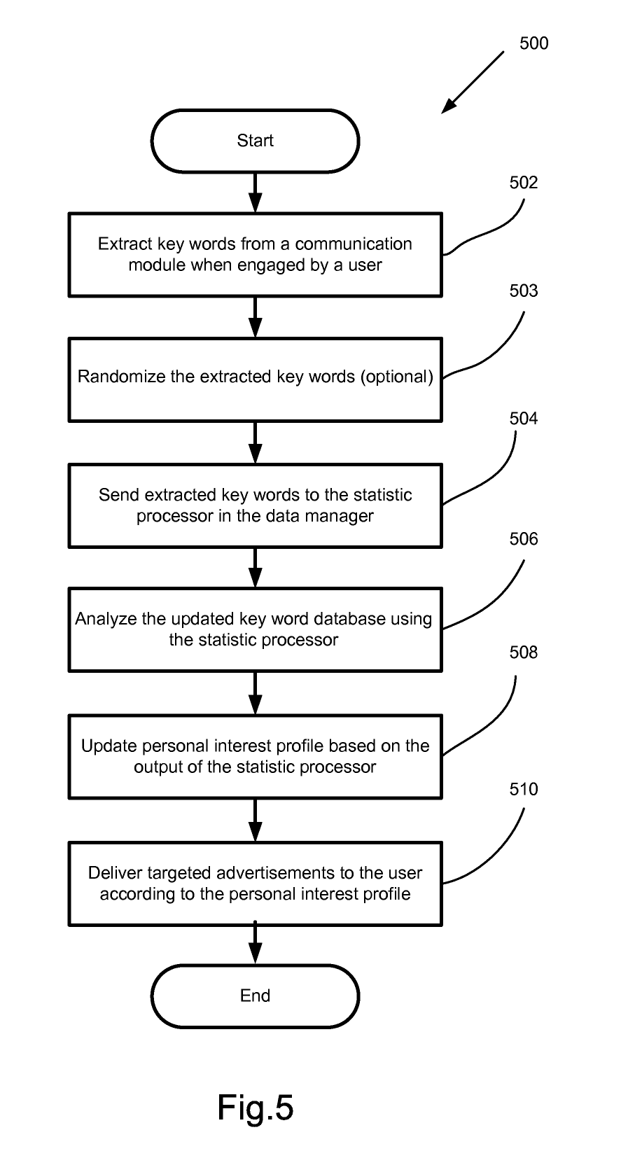

FIG. 5 is a flowchart illustrating an exemplary process that key words in a communication media file are extracted and are utilized to delivery targeted advertisements. Process 500 starts with step 502 that key words from a communication media file associated with a communication module are extracted by the key word extractor 105. The extracted key words should be a sub-set of key words from the key word library 103. In an optional step 503, the extracted key words may be randomized to further prevent the leakage of the private information included in the media file other than the key words disclosing the user's commercial interests. The key words are sent to the statistic processor 109 in step 504. The statistic processor 109 may be located in the data manager 108. The processor 109 may also be located in the computing device 104. The received key words and their counts may be analyzed by the statistic processor 109 in step 506. The received key words may be combined with a key word counting database 111 to generate a key word usage trend for a predetermined period time. In step 508, a personal interest profile may be updated based on the key words that have demonstrated significant changes in their usage trends. Highly targeted advertisements are transmitted to the computing device 104 based on the updated personal interest profile in step 510 according to one implementation of the present invention.

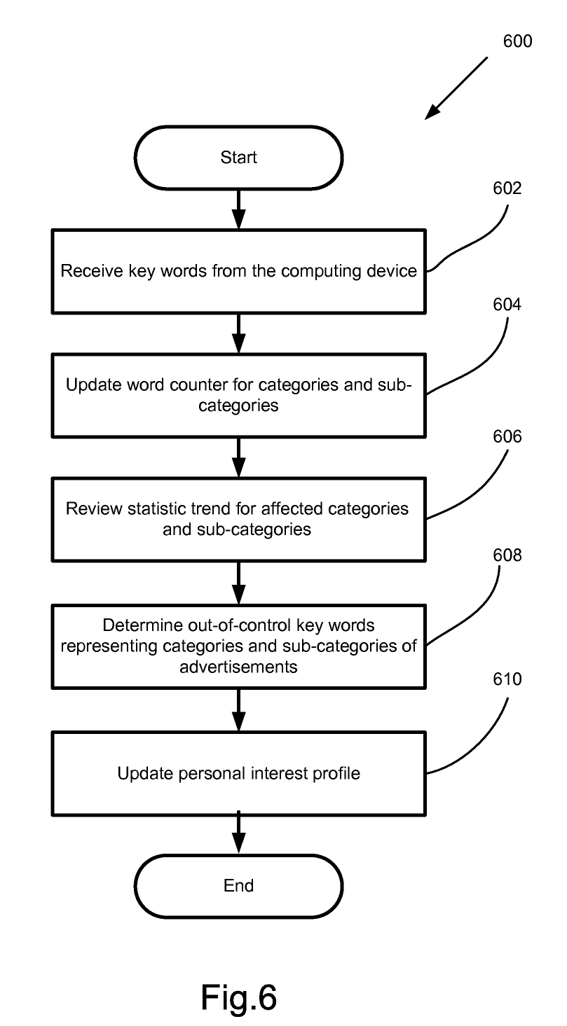

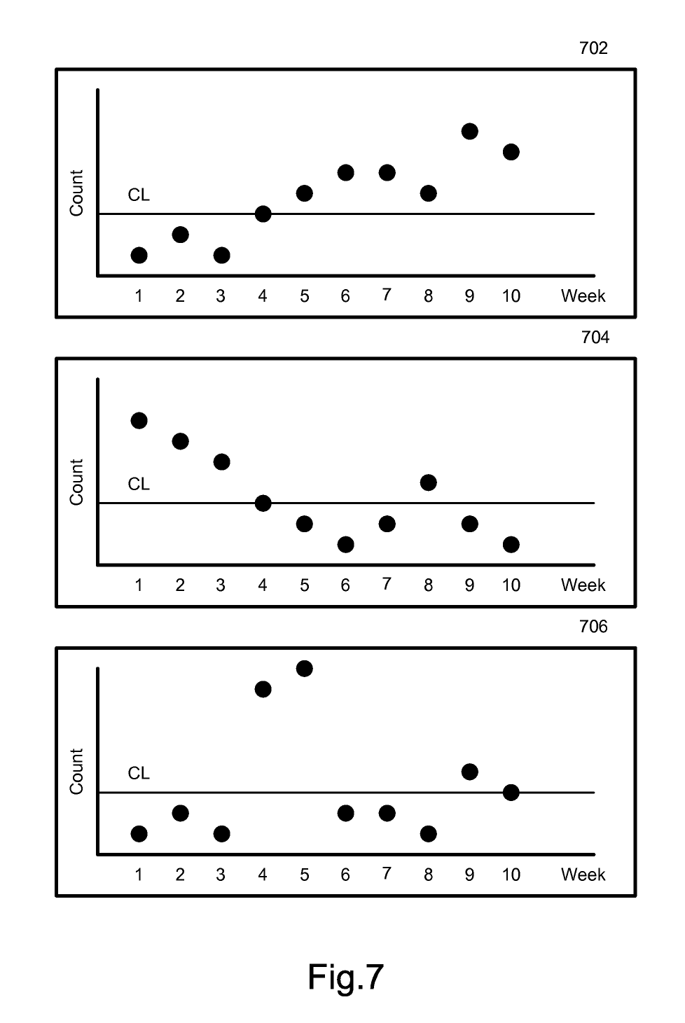

FIG. 6 is a flowchart illustrating an exemplary process that a statistic processor 109 is used to determine a significant change in anyone of keywords. Process 600 starts with step 602 that key words are received by the data manager 108 from the computing device 104. The word counts for each affected key word for categories and sub-categories of advertisements are updated in step 604. Statistic trends for affected key words are generated in step 606. The key words that have demonstrated an up-trend (702 of FIG. 7), a down-trend (704 of FIG. 7) and an excursion (706 of FIG. 7) are marked. The out of control key words representing categories and sub-categories of advertisements are determined in step 608. In step 610, the user's personal interest profile is updated based on the trend changes. The key words that have demonstrated a significant increase in usage tend will be used to determine an increase in associated commercial interests disclosed by the key words. The key words that have demonstrated a significant decrease in usage trend will be used to determine a decrease in associated commercial interests disclosed by the key words. The key words that have demonstrated an excursion may indicate a sudden increase in commercial interest of the user in a specific category or sub-category of commercial goods or services and may be utilized to generate the advertisements accordingly.

1. An advertisement delivery system comprising:
a computing device including a plurality of communication modules and a key word extractor for extracting key words defined by a key word library from a plurality of media files generated from a user's usage of the communication modules;
a statistic processor for determining usage trends of the key words; and
a means for delivering advertisements to the user based at least partially on said trends.

2. The system as recited in claim 1, wherein said statistic processor may be a part of said computing device.

3. The system as recited in claim 1, wherein said statistic processor may be connected to said computing device through a communication network.

4. The system as recited in claim 1, wherein said system further comprising a means of randomizing the extracted key words before they are sent to the statistic processor.

5. The system as recited in claim 1, wherein said system further comprising a data manager connected to the computing device through a communication network.

6. The system as recited in claim 5, wherein said data manager further including a means of connecting to a plurality of advertisers, and/or a plurality of manufactures; and/or a plurality of consumer rating/guiding organizations.

7. The system as recited in claim 1, wherein said communication modules further comprising voice communication, e-mail, SMS, on-line chat, social networks, and web browsing.

8. The system as recited in claim 1, wherein said system further comprising a voice to text converter for converting a media file in a voice format into a file in a text format.

9. The system as recited in claim 1, wherein said key word library further comprising words representing a plurality of commercial goods and services, brand names, retailers, dealers, wherein some of said key words may be the user's location related.

10. The system as recited in claim 1, wherein said statistic processor further comprising a set of predetermined rules including a control limit for gauging changes in the usage trends of the key words.

11. The system as recited in claim 1, wherein said computing device further including a device selected from the following group:
a personal computer;
a mobile communication device;
a digital television system;
a media player; and
a game console.

12. A method of delivering highly targeted advertisements to a user of computing device comprising:
extracting key words representing categories and sub-categories of advertisements by a key word extractor based on a key word library from media files generated from a user's usage of communication modules;
updating key word counters in a key word counting database;
determining by a statistic processor if there is a significant event of trend changes for anyone of key words based on a set of predetermined rules;
updating personal interest profile of the user; and
delivering advertisements according to the updated personal interest profile.

13. The method as recited in claim 12, wherein said method further comprising randomizing extracted key words.

14. The method as recited in claim 12, wherein said communication modules further comprising voice communication, e-mail, SMS, on-line chat, social networks, and web browsing.

15. The method as recited in claim 12, wherein said method further comprising a means of converting a media file in a voice format into a file in a text format.

16. The method as recited in claim 12, wherein said key word library further comprising words representing a plurality of commercial goods and services, brand names, retailers, dealers, wherein some of said key words may be the user's location related.

17. A method of determining a user's interest levels in categories and/or sub-categories of advertisements comprising:
counting usages of key words from one or a plurality of communication modules of a computing device;
trending usage rates of key words representing categories and sub-categories of advertisements over a predetermined period of time; and
determining anyone of key words demonstrating a significant trend change based on a set of predetermined rules.

18. The method as recited in claim 17, wherein said method further comprising updating a personal interest profile based on determined key words with significant trend changes.

19. The method as recited in claim 18, wherein said method further comprising delivering advertisements based on the updated personal profile.

20. The method as recited in claim 17, wherein said method further comprising converting key words in a voice format into a text format.
